(19) United States
(12) Patent Application Publication
(10) Pub. No.: US 2007/0198338 A1
(43) Pub. Date: Aug. 23, 2007

(54) Customer selected coalition systems and methods

(75) Inventor: Chaun Heywood, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/358,978

(22) Filed: Feb. 21, 2006

(51) Int. Cl. G06Q 30/00

(52) U.S. Cl. 705/14

(57) ABSTRACT

An electronic system for processing a redemption of loyalty points from a coalition of merchants. The system may include a database to store loyalty point information about a loyalty account associated with an account holder. The loyalty point information may include the amounts of loyalty points accumulated with each of the merchants in the coalition. The system may also include a processor and memory to execute a computer readable program to calculate a number of loyalty points to redeem from each of the merchants when the account holder makes the redemption. The system may further include a communications output for sending electronic messages to one or more of the merchants requesting redemption amounts based on the calculated number of loyalty points redeemed from each of the merchants.

### BACKGROUND OF THE INVENTION

Many retailers now offer loyalty programs to attract and retain customers. These programs typically allow customers to accumulate loyalty points for purchases they make with a retailer. Customers that make larger and more frequent purchases generally accumulate more points through the program. Eventually, the loyalty points may be redeemed for a variety of rewards, such as discounts on future purchases, cash back, and even free merchandise. Examples of retail businesses that use loyalty programs include supermarket chains, discount retailers, home improvement retailers, department store chains, restaurant chains, clothing retailers, telecommunications services sellers, booksellers, airlines, electronics chains, among many other businesses. Today, customers have gotten so conditioned to participating in loyalty programs, that a merchant who didn't offer one would likely be at competitive disadvantage in a retail business.

Loyalty programs are also popular in the consumer finance and credit industries. For example, many credit card providers offer loyalty programs as an incentive to sign up for and regularly use a credit card. The loyalty points are accumulated based on the money value of purchases made using the card, and may be redeemed for cash or merchandise.

Conventional loyalty programs impose certain restrictions on the customer. Generally, the loyalty points accumulated in a loyalty program account have to reach a minimum threshold before a redemption can occur. That is, the account holder must have accumulated a certain number of points before he or she can make a redemption for cash, merchandise, or a payment discount.

The loyalty points are also generally not transferable to another loyalty program. When a customer accumulates loyalty points in a program offered by one merchant, he or she usually cannot transfer those accumulated points to, for example, exceed the minimum point threshold in another loyalty account. In some instances, different retailers have a common owner, and the owner may offer a loyalty program that allows customers to accumulate and redeem among any of the commonly owned retailers. In these instances, however, the choice retailers grouped together under a common loyalty program is decided by the owner, not the customer.

The restrictions imposed by conventional loyalty programs can penalize retailers as well as customers. In many loyalty programs, a merchant or retailer has to buy the loyalty points before they can offer them to customers. In other programs, the merchant contributes a monetary value to a reserve account when awarding the points. The money deposited in the reserve account gets disbursed when the account holder goes to redeem the points. Of course, the time delay between funding the reserve account and redeeming the points can be months, or even years. This tie up of the redemption money can cost a retailer substantial amounts of money. There are also many instances of infrequent loyalty account holders who may never redeem the loyalty points they have accumulated. Contributing money a reserve account for these points is tantamount to taking that money out of the economy.

Thus, there is a need to address problems with conventional loyalty programs. These problems include customer restrictions on the retailers and merchants that customers can choose for accumulating and redeeming loyalty points. They also include the cost and waste incurred by the merchants when they fund reserves for the redemption of accumulated loyalty points. These and other problems are addressed by the present invention.

### BRIEF SUMMARY OF THE INVENTION

Embodiments of the invention include electronic systems for processing a redemption of loyalty points from a coalition of merchants. The systems may include a database to store loyalty point information about a loyalty account associated with an account holder. The loyalty point information may include the amounts of loyalty points accumulated with each of the merchants in the coalition. The systems may also include a processor and memory to execute a computer readable program to calculate a number of loyalty points to redeem from each of the merchants when the account holder makes the redemption. The systems may further include a communications output for sending electronic messages to one or more of the merchants requesting redemption amounts based on the calculated number of loyalty points redeemed from each of the merchants. The computer readable program may include instructions to determine a total number of loyalty points accumulated in the loyalty account, instructions to determine a fraction of the total accumulated loyalty points accumulated with each of the merchants, and instructions to determine the loyalty points redeemed from each of the merchants based on a product of: (1) the number of loyalty points being redeemed, and (2) the fraction of the total accumulated loyalty points held by the merchant.

Embodiments of the invention also include electronic systems that perform a loyalty point redemption from a loyalty account affiliated with a coalition of merchants. The systems may include a communications input for receiving a loyalty point redemption request from a redeeming merchant in the coalition. They may also include a database that stores loyalty point information about the loyalty account. The loyalty point information may include a total amount of loyalty points accumulated in the account, and the amounts of loyalty points accumulated with each of the merchants in the coalition. The systems may further include a processor and memory to execute a computer readable program to calculate a number of loyalty to redeem from each of the merchants to complete the loyalty point redemption, and a communications output to send electronic messages requesting a redemption amount from one or more of the merchants based on the calculated number of loyalty points redeemed. The computer readable program may include instructions to subtract the number of loyalty points being redeemed from the number of accumulated loyalty points associated with the redeeming merchant. The program may have conditional instructions where if the number of number of loyalty points being redeemed is less than the amount of loyalty points accumulated with the redeeming merchant, then all the loyalty points are redeemed from the redeeming merchant. On the other hand, if the number of number of loyalty points being redeemed exceeds the amount of loyalty points accumulated with the redeeming merchant, then the excess points are redeemed from the other merchants in the coalition in proportion to the amounts of loyalty points that have been accumulated with each of the other merchants.

Embodiments of the invention still further include methods of redeeming loyalty points from a coalition of sellers. The methods may include the steps of accumulating the loyalty points from one or more of the sellers in the coalition. They may also include redeeming at least a portion of the loyalty points to pay for at least part of a transaction with one of the sellers. Each of the sellers contributes a percentage of a redemption value for the redeemed loyalty points based on a percentage of the loyalty points accumulated with each of the sellers.

Embodiments of the invention still also include methods for redeeming loyalty points from a coalition of sellers. The methods may include the steps of accumulating the loyalty points from sellers in the coalition, and redeeming at least a portion of the loyalty points to pay for at least part of a transaction. The redemption may include first redeeming all the loyalty points accumulated with the seller participating in the transaction, and then redeeming any additional loyalty points from the other sellers in the coalition. Each of the other sellers contribute a percentage of the additional loyalty points based on a percentage of the loyalty points that have been accumulated with each of the other sellers.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-B show simplified schematics of electronic systems for processing redemptions of loyalty points according to embodiments of the invention;

FIG. 2 shows a flowchart with steps in processes of redeeming loyalty points from a coalition of merchants according to embodiments of the invention;

FIG. 3 shows a flowchart with steps in more processes of redeeming loyalty points from a coalition of merchants according to embodiments of the invention; and

FIG. 4 shows a flowchart with steps in processes of selecting coalition members for a loyalty account and redeeming loyalty points from the members.

### DETAILED DESCRIPTION OF THE INVENTION

Systems and methods are described for accumulating and redeeming loyalty points from a coalition of loyalty point providers. The providers in the coalition may be selected by a loyalty account holder from a group of members participating in the loyalty program. The loyalty account holder may accumulate loyalty points with a coalition member by purchasing goods and/or services from the member. When the account holder wishes to redeem a portion of the accumulated loyalty points, the redemption may be distributed among the coalition members according to predefined rules.

For example, embodiments include redeeming the points among the coalition members in proportion to the number of loyalty points accumulated with each member. Those members with the largest accumulation of points have the most points redeemed, even if they are not the member conducting a transaction associated with the redemption (i.e., the transaction merchant). Members with no accumulated points have no points redeemed.

In another example, the loyalty points accumulated with the transaction merchant are redeemed first, before any additional loyalty points are redeemed by other coalition members. The redemption of the additional loyalty points may be distributed among the rest of the coalition members in proportion to the number of points accumulated with the other members.

The members may contribute money at the time of the redemption, instead of at the time the points are credited to the account. In these instances, the members do not have to buy or reserve funds for the loyalty points before their redemption. Members with no accumulated points have no points redeemed and do not contribute any redemption value.

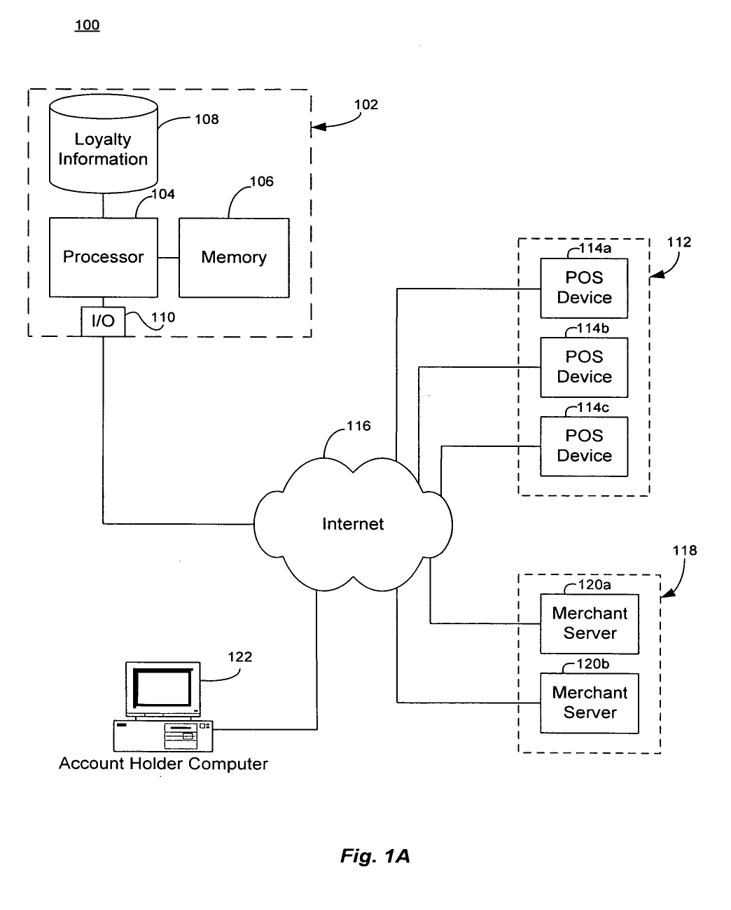

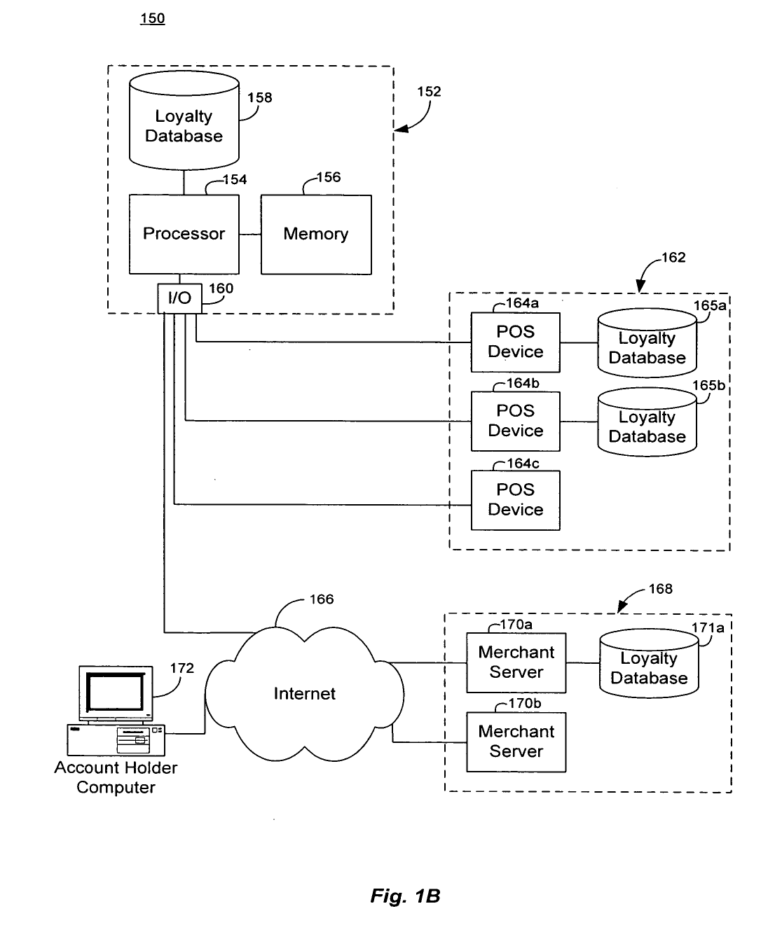

FIG. 1A shows an electronic system 100 for processing redemptions of loyalty points according to embodiments of the invention is shown. The system 100 includes a loyalty point redemption system 102 that may communicate via the Internet 116 with transaction systems at merchant store locations 112, merchant servers for Internet based commerce 118, and computers 122 through which individuals can create and manage loyalty accounts.

The loyalty point redemption system 102 may include processor 104 and memory 106 for running algorithms to determine how a redemption of loyalty points will be distributed among a coalition of members affiliated with the loyalty account. The processor 104 and memory 106 may also retrieve and update loyalty information for the loyalty accounts that is stored in a loyalty database 108 (e.g., a mass storage device such as a hard disk drive or an array of hard disk drives, a tape drive, a optical data storage drive, etc.). The system 102 also includes an input and output 110 in electronic communication with the Internet 116 for sending and receiving messages (e.g., data and instructions) to other nodes on the network.

The system 100 allows an individual to join a loyalty program through a computer 122, or some other Internet connected device. The individual may use the computer 112 to run an Internet browser program (e.g., Microsoft Internet Explorer, Netscape Navigator, Mozilla Firefox, etc.) that opens a website for opening a new loyalty account. The website may include fields for the individual to enter user identification data, which may include the individual's name and address, data of birth, telephone number, email address, a username and password for accessing the loyalty account online, credit history information, payment account information etc. This information may be sent via a secure socket link to the Internet 116 to the system 102 where a new loyalty account is created and stored in database 108.

The individual (who becomes an account holder with the creation of the loyalty account) may also choose a group of coalition members he or she wishes to affiliate with the loyalty account. The coalition members may be selected from a group of merchants, retailers, sellers, etc., that are affiliated with the loyalty program. Embodiments also include having the account holder input the names of merchants it wishes to be affiliated with the loyalty account. The system 102 may check to see if the requested merchant can be affiliated with the account.

The system 100 shows the loyalty point redemption system 102 in communication with a group transaction systems at three merchant store locations 112. Each merchant location includes a point-of-sale device 114a-c that may accept loyalty information from the account holder and transmit it to the redemption system 102 via the Internet 116. The loyalty information may input into the POS device 114 in a variety of ways, including being keyed into POS device 114 by the account holder and/or sales assistant, and being read off a loyalty card, payment card, or some other type of token during a transaction. The loyalty information being transmitted to the redemption system 114 may include a loyalty program identifier, a loyalty account identifier, an identity of the merchant, and a value of the transaction (e.g., an amount of money for purchase). The information may also include instructions for how to calculate the number of loyalty points for the transaction. In some instances, the number of loyalty points is determined at the merchant site (e.g., with the POS device 114) and transmitted to the redemption system 102.

When the loyalty information about a transaction that is received at the input 110 of system 102 may be analyzed by the processor 104. Examples include having the processor 104 determine the number of loyalty points to add to the holder's loyalty account and associate the points with a particular merchant. The loyalty point determination may include awarding points having a pre-defined value as a proportion of the valve of the transaction. For example, the processor 104 may execute an algorithm that calculates an amount of loyalty points equivalent to 0.5%, 1%, 2%, etc. of the transaction's value. The value of each loyalty point may be equivalent for all coalition members in the loyalty program. In these instances, the redemption of a loyalty point has an equal cost for each of the members.

The transaction value percentage used in the algorithm may be a default value used for all transactions associated with a particular loyalty program, account, merchant, etc. There may also be instances where instructions sent by the merchant replace the default value with a different value (e.g., a higher transaction value percentage) for a specific transaction. In addition, the merchant may send instructions to add a number of additional loyalty points to the points calculated from the transaction amount.

The processor 104 may update the loyalty information stored in database 108 with the additional loyalty points accumulated from the transaction. This may include adding the additional calculated loyalty points to the total points accumulated by the account holder in the loyalty account, as well as associating the added points with a particular coalition member. Additional information about the transaction, such as the date, time, location, description of the goods and/or services purchased, and merchant identity, among other transaction information, may also be stored in the database 108.

The system 100 also shows the loyalty point redemption system 102 in communication with a group of merchant servers 118 that can participate in Internet commerce with a computer 122 operated by the loyalty account holder. The account holder may access a website run by one of the merchant servers 120a-b to select a good or service to purchase via the Internet 116. As part of this Internet transaction, the account holder may provide loyalty account information to the merchant server 120 which the server forwards to the redemption system 102 via the Internet 116. In some instances where the account holder has a preexisting relationship with the merchant server 120, some or all of the loyalty information may already be stored on the server, which obviates the need for the account holder to supply this information to the server 120. The loyalty information supplied by the merchant server 120 to the redemption system 102 may be processed at the system 102 in the same way as loyalty information received from POS devices 114 for in store transactions.

At some point (for example when the total number of loyalty points reaches a minimum redemption threshold) the account holder may wish to redeem a portion or all of the accumulated points. The redemption system 102 may prompt the account holder to redeem loyalty points by sending messages informing the holder that he or she has accumulated points in excess of a redemption threshold. Messages may also be sent to inform the account holder of an upcoming expiration of accumulated loyalty points. These messages may be sent to an account holder's email account, as a message displayed on a webpage accessible by the account holder, as a letter mailed to the account holder, and/or as a telephone message phoned to the holder, among other ways of contacting the account holder.

The redemption may take the form of cash back, a discount on the price of a purchase, or the receipt of selected merchandise, among other options. The account holder may initiate the redemption during a transaction by informing the merchant participation in the transaction (i.e., the transaction merchant) that he or she wishes to make a redemption. The merchant may then send an authorization request to the redemption system 102 to ask if the redemption is allowed. If the transaction merchant receives a response indicating that the redemption is permitted, they proceed with the redemption and provide the account holder with the value of the redeemed points in the form of cash, discounts, merchandise, etc.

The merchant may then send the redemption information to system 102 where the redemption of the loyalty points are processed. Depending on the algorithm used by processor 104 to determine how the redemption of the points gets distributed among the coalition members, the processor 104 may update the loyalty information on database 108 to reflect the total number of redeemed points, and the points redeemed from each coalition member.

When more than one coalition member contributes to the value of the redeemed loyalty points, a variety of approaches may be taken for settling the redemption. For example, the redemption system 102 may reimburse the transaction merchant for the contributions from other coalition members, and then proceed to collect the reimbursed amount for the other merchants. In another example, the loyalty system 102 may coordinate settlements between the transaction merchant and the other coalition merchants contributing to the redemption value. In both instances, the redemption system 102 may send messages to selected coalition members requesting their contribution for the value of the redeemed loyalty points, and instructions on where to send the contribution (e.g., the redemption system 102, the transaction merchant, etc.).

Embodiments may also include allowing the account holder to redeem loyalty points directly from the redemption system 102. For example, the account holder may use computer 122 to send a request to system 102 for a cash back redemption of loyalty points. The system 102 may then credit a financial account held by the account holder with the cash back amount, and request reimbursement from loyalty account coalition members (e.g., merchants 112 and 118). Alternatively, the system 102 may coordinate contributions from selected coalition members to the account holder to fulfill the redemption request.

FIG. 1B shows another electronic system 150 for processing loyalty point redemptions according to embodiments of the invention is shown. The system 150 may include a loyalty point redemption system 152 that may communicate with coalition members 162 of a loyalty program via a private network. The private network may include elements of a legacy financial transaction network used by members 162 to conduct electronic transactions using payment cards, etc. The system 152 may also communicate with coalition members 168 and computer 172 controlled by a loyalty account holder via the Internet 166. The redemption system 152 may include a communications input and output 160 capable of sending and receiving messages across both the private network and the Internet 166.

The redemption system 152 may also include a processor 154 and memory 156 that are used to determine loyalty point redemption authorizations, coalition member contributions to a loyalty point redemption, and updates of loyalty information stored in database 158, among other operations. In system 150, the loyalty information may be distributed among a plurality of databases, including databases 165a-b that communicate with merchant POS devices 164a-b, loyalty database 171a that communicates with merchant server 170a, and loyalty database 158 that is part of redemption system 102. Loyalty information that relates to an account holder's activity with a particular merchant may be stored on a database controlled by the merchant.

For example, when the account holder conducts a transaction at a merchant store using POS device 164a, information about the transaction and the number of loyalty points accumulated may be stored in loyalty database 165a controlled by the merchant. When the account holder executes a loyalty point redemption, the redemption system 102 requests information from databases 165a in order to determine how to divide the redemption costs among the coalition members.

System 150 also includes coalition members that do not store loyalty information in a database under their control (e.g., POS device member 164c, merchant server 170b). For these members, loyalty information may be stored in the loyalty database 158 that is part of redemption system 152. The redemption system 152 may also poll member controlled databases and update database 158 with a current status for a loyalty account (e.g., information on the total loyalty points accumulated in the account). The polling may be done periodically, and/or in response to a query sent by an account holder via computer 172.

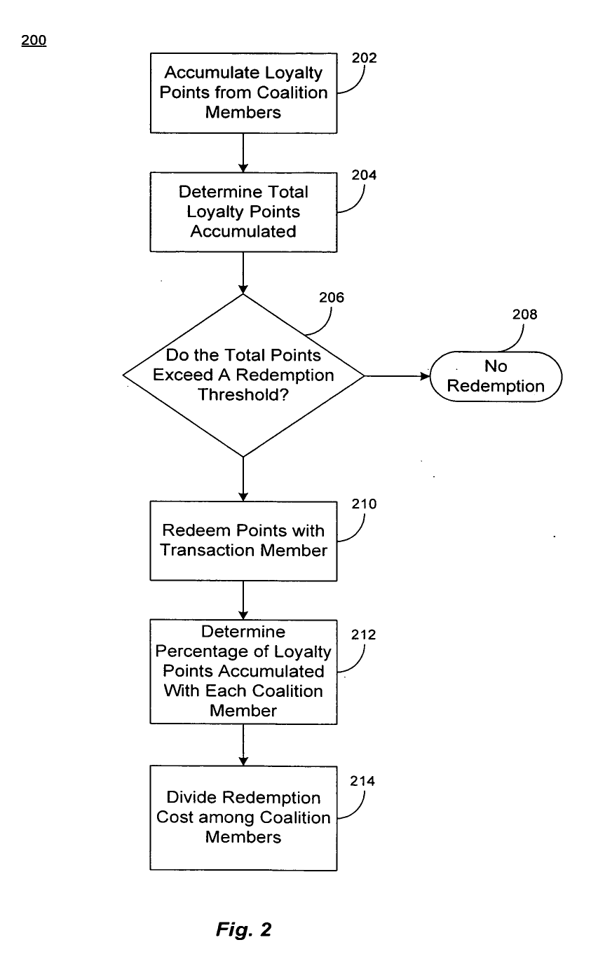

Referring now to FIG. 2, a flowchart with steps in processes of redeeming loyalty points from a coalition of merchants according to embodiments of the invention is shown. The method 200 includes the step of accumulating loyalty points from members of the coalition 202. A loyalty account holder may accumulate loyalty points by conducting transactions with one or more members of the coalition. These may include, for example, purchasing a good or service from a merchant at a merchant store. They may also include purchases of goods and/or services via the Internet, telephone, mail order, etc., from coalition members.

When the loyalty account holder wishes to redeem some of all the accumulated loyalty points, he or she may initiate a redemption with one of the coalition members. This redemption may be incorporated as part of a transaction with the member, who becomes the transaction member for the redemption.

Before the transaction member initiates the loyalty point redemption, the member may seek confirmation that the redemption can be authorized. The authorization may involve a determination of the total number of unredeemed loyalty points accumulated in the loyalty account of the account holder 204. It may also involve a determination of whether the total number of points exceeds a minimum number threshold for performing a redemption 206. If the minimum threshold has not been met, then the transaction merchant may deny the redemption request 208.

If the minimum threshold is met or exceeded, the account holder can redeem the loyalty points with the transaction member 210. When the redemption is made for a discount on the goods and/or services being purchased from the transaction member, the member may first contribute the entire redemption value, and then seek reimbursement contributions from other coalition members. In method 200, the redemption costs are divided among the coalition members based on a percentage of the loyalty points accumulated with each member. Thus, the method includes a determination of the percentage of loyalty points that the account holder has accumulated with each coalition member 212. The redemption costs are then divided among the coalition members 214 based on the percentage. For some members, this may mean no contribution to the costs if the account holder has not accumulated any loyalty points with those members.

An example of a redemption based on method 200 may be described with help of Table 1. This table shows the number of loyalty points held in a loyalty account made up of a coalition of six merchants and the loyalty account issuer. Columns in Table 1 show the number of loyalty points accumulated with each of the members before and after a redemption of 200 loyalty points.

TABLE 1
Status of Loyalty Account Before and After A 200 Point Redemption
Loyalty Account Number 5678

| | Accumulated | | | |
|---|---|---|---|---|
| | Loyalty | Percentage | Points | |
| | Points | of Total | Redeemed | Remaining |
| Member | Before | Number of | From Each | Points After |
| Name | Redemption | Loyalty Points | Member | Redemption |
| Merchant #1 | 50 | 7% | 14 | 36 |
| Merchant #2 | 500 | 72% | 143 | 357 |
| Merchant #3 | 15 | 2% | 4 | 11 |
| Merchant #4 | 20 | 3% | 6 | 14 |
| Merchant #5 | 100 | 14% | 29 | 71 |
| Merchant #6 | 0 | 0% | 0 | 0 |
| Loyalty | 15 | 2% | 4 | 11 |
| Program | | | | |
| Issuer | | | | |
| Totals | 700 | 100% | 200 | 500 |

As Table 1 illustrates, the redemption costs were distributed proportionally according to the number of points accumulated with each coalition member. Thus, Merchant #2, who had the most accumulated loyalty points, paid the largest portion of the redemption costs. Meanwhile, Merchant #6, who had no accumulated loyalty points, would not pay any of the redemption costs.

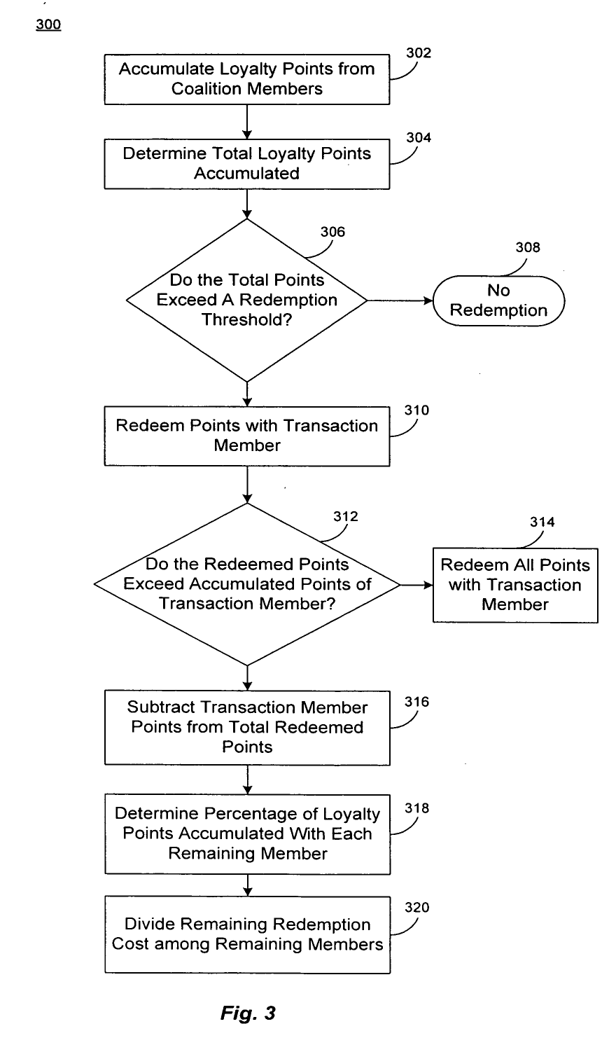

FIG. 3 shows a flowchart with steps in more processes of redeeming loyalty points from a coalition of merchants according to embodiments of the invention. Like method 200, method 300 includes accumulating loyalty points with coalition members 302, and determining a total number of accumulated, unredeemed loyalty points 304 in order to decide if a redemption of loyalty points should be authorized. For example, if the total number of accumulated loyalty points do not exceed a minimum redemption threshold 306 then the redemption will not be authorized 308.

If the redemption is authorized, a transaction member involved in a transaction that includes the redemption may redeem the points 310. In method 300, however, the transaction points are first exclusively redeemed with the transaction merchant, until all the loyalty points accumulated with that merchant have been redeemed. Afterwards, the redemption of additional points (and the cost of redeeming those points) are divided proportionally among the remaining merchants.

The redemption process in method 300 may include a determination of whether the number of redeemed loyalty points exceeds the number of points accumulated with the transaction merchant 312. If the number of accumulated loyalty points is not exceeded, then all the points (and the entire redemption cost) are redeemed exclusively with the transaction member 314.

However, if the total number of redeemed loyalty points will exceed the points accumulated with the transaction member, then the excess points are redeemed with one or more of the other coalition members. The process may include subtracting the points redeemed with the transaction member from the total number of redeemed points 316 to determine the number of excess points. It may also include determining the percentage of loyalty points accumulated with each of the remaining members 318. The redemption costs for redeeming the excess points may be divided among the remaining coalition members 320.

An example of a redemption based on method 300 may be described with help of Table 2. This table shows the number of loyalty points held in a loyalty account made up of a coalition of six merchants and the loyalty account issuer. Columns in Table 2 show the number of loyalty points accumulated with each of the members before and after a redemption of 200 loyalty points during a transaction with Merchant #5.

TABLE 2
Status of Loyalty Account Before and After Transaction with Merchant #5
Loyalty Account Number 5678

| | | Percentage | | |
|---|---|---|---|---|
| | Accumulated | of Total | Points | |
| | Loyalty Points | Number | Redeemed | Remaining |
| | Before | of Loyalty | From Each | Points After |
| Member Name | Redemption | Points | Member | Redemption |
| Merchant #1 | 50 | 8% | 8 | 42 |
| Merchant #2 | 500 | 85% | 85 | 415 |
| Merchant #3 | 15 | 2% | 2 | 13 |
| Merchant #4 | 20 | 3% | 3 | 17 |
| Merchant #5 | 100 | 0% | 100 | 0 |
| | | (Depleted) | | |
| Merchant #6 | 0 | 0% | 0 | 0 |
| Loyalty | 15 | 2% | 2 | 13 |
| Program Issuer | | | | |
| Totals | 700 | 100% | 200 | 500 |

As Table 2 illustrates, all the accumulated loyalty points were first redeemed from the transaction merchant (i.e., Merchant #5) and the remaining points redeemed proportionally according to the number of points accumulated with each remaining coalition member. Thus, Merchant #2, who had the most accumulated loyalty points, paid the largest portion of the remaining redemption costs. Meanwhile, Merchant #6, who had no accumulated loyalty points, would not pay any of the redemption costs.

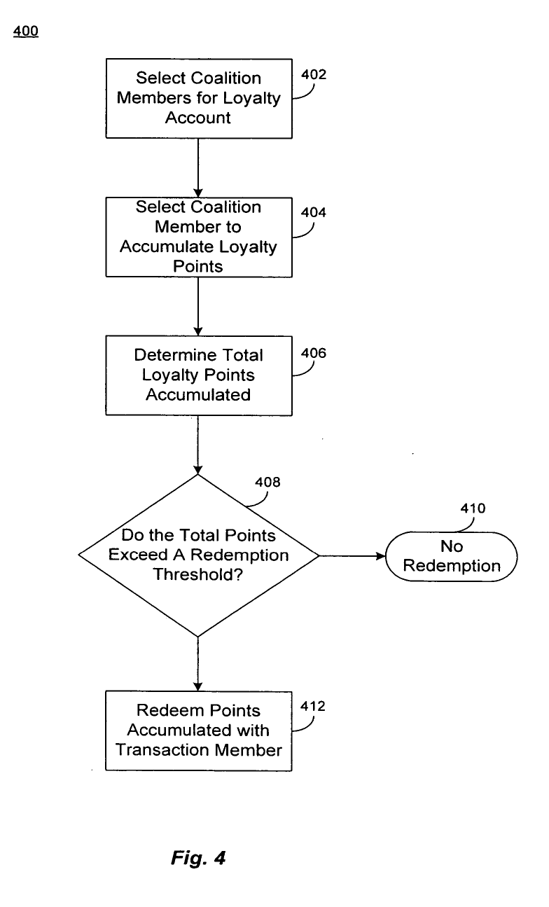

FIG. 4 shows a flowchart with steps in processes of selecting coalition members for a loyalty account and redeeming loyalty points from the members. The method 400 may include selecting a coalition of members for a loyalty account 402. This action may be done by an account holder when opening a loyalty account in a loyalty program. The account holder may select a subset of merchants, retailers, sellers, etc., from a group of members that are available to participate in the loyalty program. In addition, the account holder may request one or more merchants to be members of the coalition and the administrator of the loyalty program can determine if the requested member can join the coalition. The account holder may be able to open more than one loyalty account, with each account having a different coalition of members.

Method 400 also allows the account holder to select a coalition member to associate loyalty points with at the time they are accumulated 404. This may include allowing the account holder to select a member other than the transaction member to associate the loyalty points. For example, the account holder may accumulate the loyalty points through a transaction with a first coalition member, and then associate those points with a second coalition member. The account holder may be allowed to associate all the points with the second member, or divide the points between the first and second members.

The loyalty program may also have default instructions to divide accumulated loyalty points equally among all the coalition members as they are accumulated. For example, when the account holder receives loyalty points from a transaction merchant, the default instructions will automatically divide the points among all the coalition members. Default instructions may also include dividing the points in predefined percentages, and/or dividing the points among a subset the coalition members.

The loyalty program may also include exclusionary rules that prevent the account holder from selecting competing merchants as members of the coalition. For example, if the account holder selects a first supermarket chain as a member of the coalition, an exclusionary rule may prevent the holder from also selecting a second, competing supermarket chain. Similar rules may be applied for competing gas station merchants, convenience store chains, general merchandise retailers, home improvement merchants, clothing store retailers, transportation providers (e.g., airlines, rental car businesses), lodging providers, electronics retailers, movie theater chains, etc.

When an account holder selects coalition members from a home computer or electronic kiosk, the exclusionary rules may be presented by graying out or eliminating members from a display of potential members. Thus when the account holder selects a first home improvement merchant for the coalition, the display will indicate that one or more competing home improvement merchants is no longer selectable. If the account holder deselects the first home improvement merchant, the display may indicate that the previously unselectable merchants are now available for the coalition. The display may also show a text message indicating that certain potential coalition members are no longer available with the selection of a particular member.

Method 400 also includes a process of redeeming accumulated loyalty points. This process may include determining whether a redemption can be authorized by determining the total number of loyalty points accumulated in the account 406, and determining if this number exceeds a minimum redemption threshold 408. If not, the redemption will not be authorized 410. If yes, then the points will be redeemed with the transaction merchant 412 up to the number of points accumulated with that transaction merchant.

An example of a redemption based on method 400 may be described with help of Table 3. This table shows the number of loyalty points held in a loyalty account made up of a coalition of six merchants and the loyalty account issuer. Columns in Table 3 show the number of loyalty points accumulated with each of the members before and after a redemption of 100 loyalty points during a transaction with Merchant #5.

TABLE 3
Status of Loyalty Account Before and After Redemtion with Merchant #5
Loyalty Account Number 5678

| | Accumulated | | | |
|---|---|---|---|---|
| | Loyalty | Percentage of | Points | |
| | Points | Total | Redeemed | Remaining |
| Member | Before | Number of | From Each | Points After |
| Name | Redemption | Loyalty Points | Member | Redemption |
| Merchant #1 | 50 | N/A | 0 | 50 |
| Merchant #2 | 500 | N/A | 0 | 500 |
| Merchant #3 | 15 | N/A | 0 | 15 |
| Merchant #4 | 20 | N/A | 0 | 20 |
| Merchant #5 | 100 | N/A | 100 | 0 |
| Merchant #6 | 0 | N/A | 0 | 0 |
| Loyalty | 15 | N/A | 0 | 15 |
| Program | | | | |
| Issuer | | | | |
| Totals | 700 | N/A | 100 | 600 |

As Table 3 illustrates, all the accumulated loyalty points were redeemed from the transaction merchant (i.e., Merchant #5). The maximum number of points that can be redeemed with this method is equal to the number of points accumulated with the transaction merchant. No point are redeemed with the other members of the merchant coalition.

It should be appreciated that the particular combinations of steps described in FIGS. 2-4 can be interchanged to form new combinations. For example, the steps of selecting coalition members described in method 400 may be used in combination with the steps of determining the division of redemption costs described in method 200 and 300. Many other combinations are also possible.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. An electronic system for processing a redemption of loyalty points from a coalition of merchants, the system comprising:
a database to store loyalty point information about a loyalty account associated with an account holder, wherein the loyalty point information comprises the amounts of loyalty points accumulated with each of the merchants in the coalition;
a processor and memory to execute a computer readable program to calculate a number of loyalty points to redeem from each of the merchants when the account holder makes the redemption; and
a communications output for sending electronic messages to one or more of the merchants requesting redemption amounts based on the calculated number of loyalty points redeemed from each of the merchants, and
wherein the computer readable program comprises:
instructions to determine a total number of loyalty points accumulated in the loyalty account;
instructions to determine a fraction of the total accumulated loyalty points accumulated with each of the merchants; and
instructions to determine the loyalty points redeemed from each of the merchants based on a product of: (1) the number of loyalty points being redeemed, and (2) the fraction of the total accumulated loyalty points held by the merchant.

2. The system of claim 1, wherein the merchants do not purchase the loyalty points before the account holder makes a redemption.

3. The system of claim 1, wherein the account holder accumulates loyalty points with one of the merchants by purchasing a good or service from the merchant.

4. The system of claim 3, wherein each of the merchants set a number of loyalty points to award for a purchase independently from the other merchants.

5. The system of claim 1, wherein a merchant is not sent a message requesting a redemption when the database has zero accumulated loyalty points associated with the merchant for the loyalty account.

6. The system of claim 1, wherein the processor updates the loyalty point information by subtracting the redeemed loyalty points from the loyalty account.

7. The system of claim 1, wherein the loyalty point information includes dates that the loyalty points were accumulated in the account.

8. The system of claim 7, wherein the processor updates the loyalty point information by subtracting expired loyalty points from the loyalty account.

9. An electronic system that performs a loyalty point redemption from a loyalty account affiliated with a coalition of merchants, the system comprising:
a communications input for receiving a loyalty point redemption request from a redeeming merchant in the coalition;
a database that stores loyalty point information about the loyalty account, wherein the loyalty point information comprises a total amount of loyalty points accumulated in the account, and the amounts of loyalty points accumulated with each of the merchants in the coalition;
a processor and memory to execute a computer readable program to calculate a number of loyalty to redeem from each of the merchants to complete the loyalty point redemption; and
a communications output to send electronic messages requesting a redemption amount from one or more of the merchants based on the calculated number of loyalty points redeemed, and
wherein the computer readable program comprises:
instructions to subtract the number of loyalty points being redeemed from the number of accumulated loyalty points associated with the redeeming merchant, wherein if the number of number of loyalty points being redeemed is less than the amount of loyalty points accumulated with the redeeming merchant, then all the loyalty points are redeemed from the redeeming merchant, and wherein if the number of number of loyalty points being redeemed exceeds the amount of loyalty points accumulated with the redeeming merchant, then the excess points are redeemed from the other merchants in the coalition in proportion to the amounts of loyalty points that have been accumulated with each of the other merchants.

10. The system of claim 9, wherein the merchants do not purchase the loyalty points before the redemption is made.

11. The system of claim 9, wherein the communications input is adapted to receive merchant messages that include an additional amount of loyalty points from a specified merchant to be added to the loyalty account.

12. The system of claim 11, wherein the loyalty point information is updated in the database by adding the additional amount of loyalty points to the amount of loyalty points accumulated with the specified merchant.

13. A method of redeeming loyalty points from a coalition of sellers, the method comprising:
accumulating the loyalty points from one or more of the sellers in the coalition;
redeeming at least a portion of the loyalty points to pay for at least part of a transaction with one of the sellers, wherein each of the sellers contributes a percentage of a redemption value for the redeemed loyalty points based on a percentage of the loyalty points accumulated with each of the sellers.

14. The method of claim 13, wherein the transaction with one of the sellers comprises purchasing a good or a service from the seller.

15. The method of claim 13, wherein the sellers do not contribute the percentage of the redemption value for the loyalty points before the loyalty points are redeemed.

16. The method of claim 13, wherein the loyalty points are accumulated with one of the sellers by purchasing a good or service from the seller.

17. The method of claim 16, wherein the loyalty points accumulated with the purchase of the good or service have a value ranging from 1% to 2% of a purchase price for the good or service.

18. The method of claim 16, wherein the loyalty points accumulated with the purchase of a good or service have a value set by each of the sellers in the coalition.

19. The method of claim 18, wherein the loyalty points accumulated with the purchase of the good or service from a first seller has a value of 1% of a purchase price of the good or service, and the loyalty points accumulated with the purchase of the good or service from a second seller has a value of 3% of the purchase price.

20. The method of claim 13, wherein each of the redeemed loyalty points has an equal redemption value.

21. The method of claim 13, wherein no loyalty points have been accumulated with one or more of the sellers.

22. The method of claim 21, wherein the sellers having no accumulated loyalty points contribute nothing to the redemption value for the redeemed loyalty points.

23. The method of claim 13, wherein the sellers in the coalition are selected by a person who does the redemption of the loyalty points.

24. The method of claim 13, wherein the portion of the loyalty points being redeemed has to exceed a threshold number of loyalty points.

25. The method of claim 13, wherein the accumulated loyalty points can expire if they are not redeemed within a predefined period of time.

26. The method of claim 25, wherein the predefined period of time is one year from a date the points were awarded.

27. A method for redeeming loyalty points from a coalition of sellers, the method comprising:
accumulating the loyalty points from sellers in the coalition;
redeeming at least a portion of the loyalty points to pay for at least part of a transaction, wherein the redemption includes first redeeming all the loyalty points accumulated with the seller participating in the transaction, and then redeeming any additional loyalty points from the other sellers in the coalition, wherein each of the other sellers contribute a percentage of the additional loyalty points based on a percentage of the loyalty points that have been accumulated with each of the other sellers.

28. The method of claim 27, wherein the sellers do not reserve money for the accumulated loyalty points until the points are redeemed.

29. The method of claim 27, wherein the loyalty points are accumulated with one of the sellers by purchasing a good or service from the seller.

30. The method of claim 29, wherein the loyalty points accumulated with the purchase of the good or service is proportional to a value of the good or service.

31. The method of claim 29, wherein each of the sellers can independently set the number of loyalty points awarded for the purchase.
